(19) United States
(12) Patent Application Publication
(10) Pub. No.: US 2022/0328930 A1
(43) Pub. Date: Oct. 13, 2022

(54) SEPARATOR FOR LITHIUM SECONDARY BATTERY AND METHOD FOR MANUFACTURING SAME

(71) Applicants: Hyundai Motor Company, Seoul (KR); Kia Corporation, Seoul (KR); Daegu Gyeongbuk Institute of Science and Technology, Daegu (KR)

(72) Inventors: Dong Jun KIM, Seongnam (KR); Yoon Sung LEE, Suwon (KR); Young Woo LEE, Suwon (KR); Da Hee JIN, Daegu (KR); Young Joon ROH, Daegu (KR); Yong Min LEE, Daegu (KR); Seoung Woo BYUN, Daejeon (KR)

(21) Appl. No.: 17/455,589

(22) Filed: Nov. 18, 2021

(30) Foreign Application Priority Data
Apr. 7, 2021 (KR) 10-2021-0045198

(51) Int. Cl. H01M 50/446; H01M 50/403; H01M 10/0525

(52) U.S. Cl. CPC H01M 50/446; H01M 50/403; H01M 10/0525

(57) ABSTRACT

Disclosed is a separator for a lithium secondary battery coated with a ceramic particle.

### CROSS REFERENCE TO RELATED APPLICATION

The present application claims priority of Korean Patent Application No. 10-2021-0045198 filed on Apr. 7, 2021, the entire contents of which is incorporated herein for all purposes by this reference.

### TECHNICAL FIELD

The present invention relates to a separator configuring a lithium secondary battery. Specifically, the present invention relates to a separator in which a surface of a porous membrane substrate capable of being used as a separator is coated with a ceramic.

### BACKGROUND

A lithium secondary battery is largely composed of an anode, a cathode, a separator, and an electrolyte. The separator as a microporous polymer membrane with pores in the size of nanometers to micrometers serves to prevent the anode and the cathode from directly contacting each other and becomes a movement passage of lithium ions.

To secure stability and long-term reliability of the lithium secondary battery, the separator has been coated with a ceramic material. However, the ceramic coating may be separated from the inside of the battery to become impurities when not securing an adhesive force with the porous membrane substrate. Particularly, the adhesive force may be largely reduced when the ceramic coating is impregnated into the electrolyte, and the separated ceramic coating may be floated in the lithium secondary battery, thereby causing side reactions with other materials or lowering stability of the lithium secondary battery.

Therefore, there is the need for a separator capable of securing the adhesive force of the ceramic coating and a method for manufacturing the same.

The foregoing explained as the background is intended merely to aid in the understanding of the background of the present invention, and is not intended to mean that the present invention falls within the purview of the related art that is already known to those skilled in the art.

### SUMMARY

In preferred aspects, provided is a separator for a lithium secondary battery and a lithium secondary battery using the same, which may coat ceramic particles on a porous membrane substrate through a chemical cross-linking reaction. As such, an adhesive force between the porous membrane substrate and the ceramic particles can be improved substantially to secure thermal stability the same as or better than stability of the conventional separator even with coating of low mass ceramic particles through the increased adhesive force, and to improve an energy density of the lithium secondary battery.

Provided is a method for manufacturing a separator for a lithium secondary battery, which may include: manufacturing a first solution including a first polymer including at least one non-tertiary amine group; forming a first polymer membrane including at least one non-tertiary amine group on a surface of a ceramic particle by distributing the ceramic particle to the first solution manufactured by the first solution manufacturing step; manufacturing a second solution including a second polymer including at least one carboxyl group; manufacturing a coating material including the second solution including the second polymer and the ceramic particle formed in the first polymer membrane; coating the coating material manufactured by the coating material manufacturing step on one surface or both surfaces of the porous membrane substrate; and cross-linking a substrate coated with the coating material through thermal polymerization.

The first polymer may further include a catechol group and an amine group.

The first polymer may include polydopamine.

The “polydopamine” as used herein refers to a polymer formed by polymerizing dopamine monomers constituting greater than 85 wt %, 86 wt %, 87 wt %, 88 wt %, 89 wt %, 90 wt %, 91 wt %, 92 wt %, 93 wt %, 94 wt %, 95 wt % 96 wt %, 97 wt %, 98 wt %, or 99 wt % of the total weight of the polymer. In certain aspect, the polydopamine as being used or included in a binder may increase adhesion property of the binder.

The second polymer containing at least one carboxyl group may include one or more selected from the group consisting of polyacrylic acid, carboxymethyl cellulose, polyethyleneimine, and trimesoyl chloride.

The ceramic particle may include one or more selected from the group consisting of Al₂O₃, SnO₂, ZrO₂, SiO₂, and TiO₂.

A weight ratio of the ceramic particle included in the coating material and the second solution may be about 1:1 to 40:1.

The porous membrane substrate may include one or more selected from the group consisting of a polyolefin-based resin comprising polyethylene and polypropylene, a fluorine-based resin containing polyvinylidenefluoride and polytetrafluoroethylene, and a polyester-based resin.

The porous membrane substrate may include a pore having a size of about 0.03 to 1 μm. The porous membrane substrate may have a porosity of about 30 to 50%, and a thickness of about 10 to 30 μm.

The separator for the lithium secondary battery according to various exemplary embodiments the present invention may substantially improve thermal stability of the separator for the lithium secondary battery and increase electrochemical properties of the lithium secondary battery. Further, performance of the separator may be improved at the lower weight, thereby improving the energy density of the lithium secondary battery.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 shows an exemplary method for manufacturing a separator for a lithium secondary battery according to an exemplary embodiment of the present invention.

FIG. 2 shows an exemplary separator manufactured according to an exemplary embodiment of the present invention.

FIG. 3 shows an XPS analysis result for ceramic particles before and after coating of a coating material.

FIGS. 4 and 5 show measurement results of an adhesive force for the separator manufactured according to an exemplary embodiment of the present invention.

FIG. 6 shows an experimental result for confirming thermal properties of the separator manufactured according to the exemplary embodiment of the present invention (Example 1), a separator coated with a ceramic commercially available (Comparative Example 2), and a polyolefin fabric (Comparative Example 3).

FIGS. 7 and 8 show measurement results of electrochemical properties and for evaluating thermal stability of the lithium secondary battery manufactured by using the separator manufactured according to exemplary embodiment of the present invention (Example 1), the separator coated with the ceramic commercially available (Comparative Example 2), and the polyolefin fabric (Comparative Example 3).

### DETAILED DESCRIPTION

As described herein, objects, other objects, features, and advantages according to the present invention will be readily understood through the following preferred embodiments associated with the accompanying drawings. However, the present invention is not limited to the embodiments described herein and may also be embodied in other forms. Rather, the embodiments introduced herein are provided so that the invention may be made thorough and complete, and the spirit according to the present invention may be sufficiently conveyed to those skilled in the art.

In this specification, it should be understood that terms such as “comprise” or “have” are intended to indicate that there is a feature, a number, a step, an operation, a component, a part, or a combination thereof described on the specification, and do not exclude the possibility of the presence or the addition of one or more other features, numbers, steps, operations, components, parts, or combinations thereof. Further, when a portion such as a layer, a film, a region, or a plate is referred to as being “above” the other portion, it may be not only “right above” the other portion, or but also there may be another portion in the middle. On the contrary, when a portion such as a layer, a film, a region, or a plate is referred to as being “under” the other portion, it may be not only “right under” the other portion, or but also there may be another portion in the middle.

Unless otherwise indicated, all numbers, values, and/or expressions referring to quantities of ingredients, reaction conditions, polymer compositions, and formulations used herein are to be understood as modified in all instances by the term “about” as such numbers are inherently approximations that are reflective of, among other things, the various uncertainties of measurement encountered in obtaining such values.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Further, where a numerical range is disclosed herein, such range is continuous, and includes unless otherwise indicated, every value from the minimum value to and including the maximum value of such range. Still further, where such a range refers to integers, unless otherwise indicated, every integer from the minimum value to and including the maximum value is included.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The term “solution” as used herein includes true solutions as well as admixtures, dispersions and other mixtures of materials that may not form a trus solution.

Hereinafter, exemplary contents for achieving the aforementioned object and solving the aforementioned problem will be described in detail with reference to the accompanying drawings. Meanwhile, in understanding the present invention, specific descriptions of known techniques in the same field will be omitted when not helping to understand the core contents of the invention, and the technical spirit of the present invention is not limited thereto and may be variously modified and implemented by those skilled in the art.

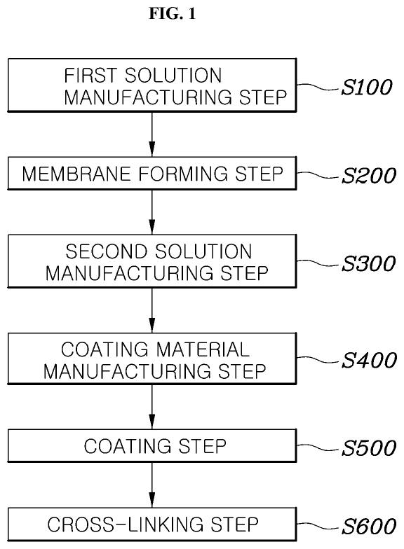

FIG. 1 shows an exemplary method for manufacturing a separator for a lithium secondary battery according to an exemplary embodiment of the present invention. A method for manufacturing a separator for a lithium secondary battery may include: a first solution manufacturing step (S100) which manufactures a first solution including a first polymer containing at least one non-tertiary amine group; a membrane forming step (S200) which forms a first polymer membrane containing at least one non-tertiary amine group on a surface of a ceramic particle by distributing the ceramic particle to the first solution manufactured by the first solution manufacturing step; a second solution manufacturing step (S300) which manufactures a second solution containing a second polymer containing at least one carboxyl group; a coating material manufacturing step (S400) which manufactures a coating material by mixing the second solution containing the second polymer with the ceramic particle formed with the first polymer membrane; a coating step (S500) which coats the coating material manufactured by the coating material manufacturing step on one surface or both surfaces of a porous membrane substrate; and a cross-linking step (S600) which chemically cross-links a substrate coated with the coating material through thermal polymerization.

The porous membrane substrate for manufacturing the separator for the lithium secondary battery may include one or more selected from the group consisting of a polyolefin-based resin containing polyethylene and polypropylene, a fluorine-based resin containing polyvinylidenefluoride and polytetrafluoroethylene, and a polyester-based resin. This is illustrative and a resin, a non-woven fabric, or the like with pores capable of manufacturing a separator may be used.

Such a porous membrane substrate may have pores having a size of about 0.03 to 1 μm, and may have a porosity of about 30 to 50% and a thickness of about 10 to 30 μm.

Further, the ceramic particle may include one or more selected from the group consisting of Al₂O₃, SnO₂, ZrO₂, SiO₂, and TiO₂. This is illustrative and the ceramic particle may use an inorganic particle generally used in the corresponding field.

Meanwhile, the first polymer constituting the first solution may be characterized by simultaneously having a catechol group and am amine group, and the first polymer may be polydopamine which is a polymer of dopamine.

Further, the second polymer constituting the second solution may include one or more selected from the group consisting of polyacrylic acid, carboxymethyl cellulose, polyethyleneimine, and trimesoyl chloride. This is illustrative and the second solution may be manufactured by using a polymer compound with at least one carboxyl group.

A weight ratio of the ceramic particle included in the coating material and the second solution may be about 1:1 to 40:1.

When the second solution is excessive beyond the above values, the ceramic particle may be separated more actively and wettability of the separator may be lowered, and even if the second solution is insufficient, an adhesive force between the ceramic particles is lowered, such that the ceramic particle may be separated more actively.

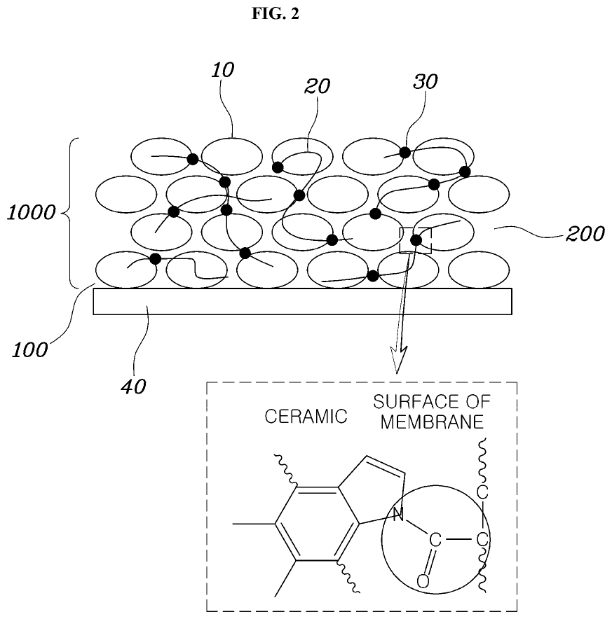

FIG. 2 shows the separator manufactured by the above steps.

The separator coated with the ceramic particles may include a coating layer 1000 on which the cross-linking reaction is performed through thermal polymerization on one surface or both surfaces of a porous membrane substrate 40, including the first polymer containing an amine group and the second polymer containing a carboxyl group, and the formed cross-linking may contain at least one peptide group. In other words, the second polymer of the second solution serves as a binder 30. The binder 30 may form a cross-linking point 20 between ceramic particles 10, thereby increasing the adhesive force between the ceramic particles 10.

The separator coated with the ceramic particles 10 may minimize the separation of the ceramic particles 10, and may be coated with the ceramic particles with a lower mass than that of a conventional separator to secure thermal stability of the separator which is the same as or better than that of the conventional separator, thereby increasing an energy density of the battery.

### Example

Hereinafter, an experimental result of the separator manufactured by the manufacturing method according to the present invention will be described. First, the ceramic particle contained Al₂O₃, the first polymer used polydopamine, and the second polymer used polyacrylic acid, thereby manufacturing the separator.

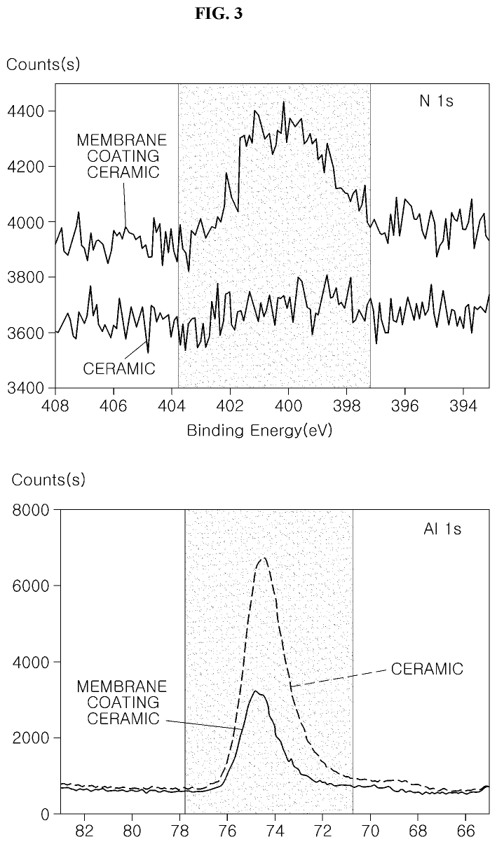

FIG. 3 shows an XPS analysis result for the ceramic particle before and after coating of the coating material, and an N peak was detected on the coated surface of the ceramic particle, and a peak of Al which is a component of the ceramic particle was reduced.

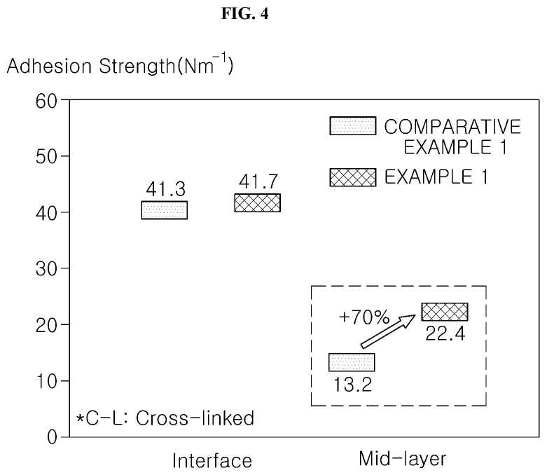

FIG. 4 shows a measurement result of an adhesive force for the separator manufactured according to an exemplary embodiment of the present invention. The adhesive force was measured by surface and interfacial cutting analysis system (SAICAS) equipment, and the adhesive forces in Example 1 in which the cross-linking according to the present invention was performed and Comparative Example 1 in which the coating of the ceramic particle and the cross-linking were not performed were measured.

Further, as shown in FIG. 2, the adhesive force was measured at an interface 100 between the porous membrane substrate and the coating layer and a mid-layer 200 of the coating layer.

As the experimental result, the adhesive forces at the portion of the interface 100 between the substrate on which it is difficult to form the cross-linking and the coating layer are similar to each other, but the adhesive force in Example 1 was highly measured by 70% or greater at the mid-layer 200 of the coating layer in which the cross-linking may be performed.

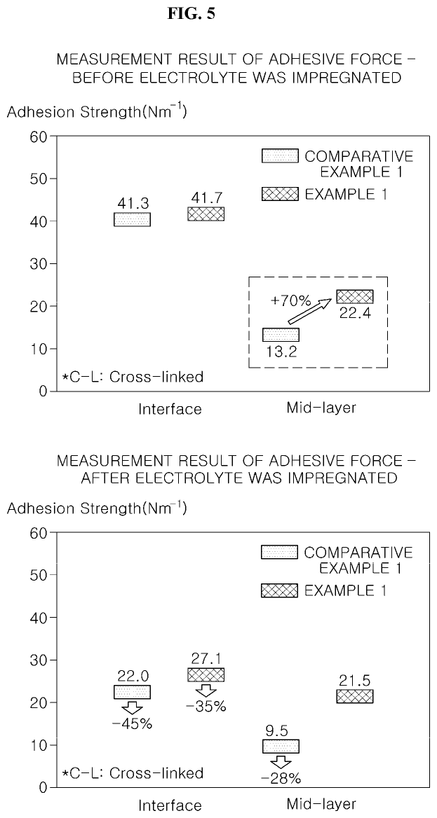

FIG. 5 shows the measurement result of the adhesive force for the separator manufactured according to an exemplary embodiment of the present invention, and the adhesive force was measured by being divided into before and after an electrolyte was impregnated. FIG. 5 shows the measurement result after the electrolyte was impregnated.

The adhesive force was measured by the surface and interfacial cutting analysis system (SAICAS) equipment, and the adhesive forces in Example 1 in which the cross-linking was performed and Comparative Example 1 in which the coating of the ceramic particle and the cross-linking were not performed were measured. The adhesive force was measured after impregnating the separator into a general electrolyte for 12 hours, and then drying the surface of the separator.

As shown in FIG. 5, the adhesive force at the portion of the interface 100 between the substrate on which it is difficult to form the cross-linking and the coating layer was reduced by about 30 to 40% in all of Example 1 and Comparative Example 1, but at the mid-layer 200 of the coating layer in which the cross-linking may be performed, the adhesive force in Example 1 was not almost reduced, and the adhesive force in Comparative Example 1 was reduced by about 28%.

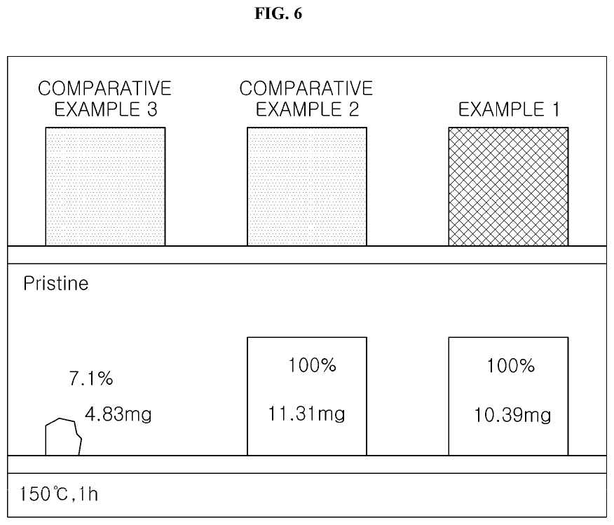

FIG. 6 shows experimental results for confirming thermal properties of the separator manufactured according to an exemplary embodiment of the present invention (Example 1), a separator coated with a ceramic commercially available (Comparative Example 2), and a polyolefin fabric (Comparative Example 3).

To understand the thermal properties of the separator, each of the separators was cut by 3×3 cm² to be exposed for 1 hour under the circumstance of 150 degrees Celsius.

As the experimental result, it was shown that Comparative Example 3 was contracted, leaving only 7.1% of the existing size, but Example 1 showed the same performance as that in Comparative Example 2. The Example 1 shows the same performance at a lower coating weight by about 15% than that in Comparative Example 2. Therefore, the case of using the separator according to the present invention may reduce the weight of the material, thereby increasing the energy density of the lithium secondary battery.

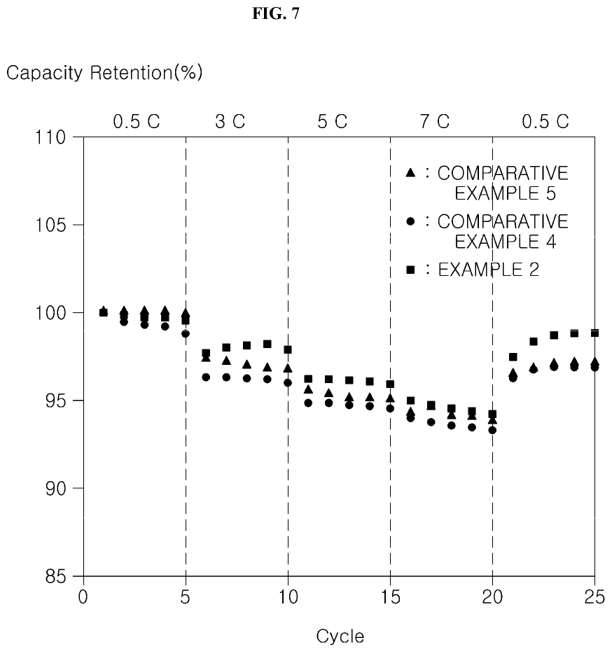

FIG. 7 shows measurement results of electrochemical properties of the lithium secondary battery manufactured by using the separator manufactured according to an exemplary embodiment of the present invention (Example 1), the separator coated with a ceramic commercially available (Comparative Example 2), and the polyolefin fabric (Comparative Example 3).

A capacity retention rate was measured by manufacturing the lithium secondary battery by using NCM811 as an anode and graphite as a cathode, mixing EC:EMC:DEC at a weight ratio of 25:45:30 as an electrolyte, each adding LiFSI and LiPF₆ by 0.5 M as a lithium salt, and adding VC as an additive.

The capacity retention rate was measured while conducting CC/CV charging at a 0.5 C-rate and CC discharging at a 0.5 C-rate for 5 cycles in total, conducting the CC/CV charging at the 0.5 C-rate and each of 3 C, 5 C, and 7 C discharging at the 0.5 C-rate for 5 cycles, and then conducting the CC/CV charging at the 0.5 C-rate and the CC discharging at the 0.5 C-rate again for 5 cycles.

The lithium secondary battery using the separator in Example 1 was represented as an Example 2, the lithium secondary battery using the separator in Comparative Example 2 was represented as a Comparative Example 4, and the lithium secondary battery using the separator in Comparative Example 3 was represented as a Comparative Example 5.

As shown in FIG. 7, Example 2 showed the result showing the capacity retention rate which is the same as or more than those in Comparative Examples 4 and 5.

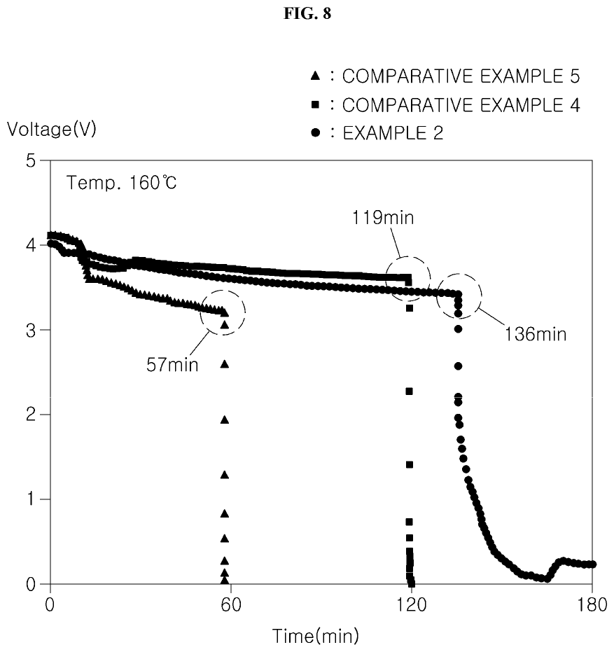

FIG. 8 shows evaluation of thermal stability of the lithium secondary battery manufactured by using the separator manufactured according to the exemplary embodiment of the present invention (Example 1), the separator coated with a ceramic commercially available (Comparative Example 2), and the polyolefin fabric (Comparative Example 3).

The lithium secondary battery using the separator in Example 1 was represented as Example 2, the lithium secondary battery using the separator in Comparative Example 2 was represented as Comparative Example 4, and the lithium secondary battery using the separator in Comparative Example 3 was represented as Comparative Example 5.

An open circuit voltage (OCV) was measured by conducting the CC charging/discharging at a 0.1 C-rate to undergo a formation process, then conducting the CC/CV charging at a 0.2 C-rate and the CC discharging at a 0.2 C-rate for 3 cycles, and then conducting the CC/CV charging at a 0.2 C-rate for the manufactured lithium secondary battery, and then exposing for the manufactured lithium secondary battery under a high-temperature circumstance at 160 degrees Celsius.

As shown in FIG. 8, an internal short circuit occurred at 57 minutes in the lithium secondary battery corresponding to Comparative Example 5 and a short circuit occurred at 119 minutes in the lithium secondary battery corresponding to Comparative Example 4. Further, a short circuit occurred at 136 minutes in the lithium secondary battery corresponding to Example 2 and Example 2 had a longer short-circuit time than those in Comparative Examples 4 and 5 because the increase in the adhesive force due to the cross-linking and the decrease in the adhesive force due to the impregnation of the electrolyte were suppressed.

While the exemplary embodiment of the present invention has been illustrated and described, it will be apparent to those skilled in the art that the present invention may be variously improved and changed without departing from the technical spirit of the present invention provided by the appended claims.

What is claimed is:

1. A method for manufacturing a separator for a lithium secondary battery, comprising:
manufacturing a first solution comprising a first polymer comprising at least one non-tertiary amine group;
forming a first polymer membrane comprising at least one non-tertiary amine group on a surface of a ceramic particle by distributing the ceramic particle to the first solution manufactured by the first solution manufacturing step;
manufacturing a second solution comprising a second polymer comprising at least one carboxyl group;
manufacturing a coating composition comprising the second solution comprising the second polymer and the ceramic particle in the first polymer membrane;
coating the coating material manufactured by the coating material manufacturing step on one surface or both surfaces of the porous membrane substrate; and
cross-linking a substrate coated with the coating material through thermal polymerization.

2. The method of claim 1, wherein the first polymer further comprises a catechol group and an amine group.

3. The method of claim 1, wherein the first polymer is polydopamine.

4. The method of claim 1, wherein the second polymer comprises one or more selected from the group consisting of polyacrylic acid, carboxymethyl cellulose, polyethyleneimine, and trimesoyl chloride.

5. The method of claim 1, wherein the ceramic particle comprises one or more selected from the group consisting of Al₂O₃, SnO₂, ZrO₂, SiO₂, and TiO₂.

6. The method of claim 1, wherein a weight ratio of the ceramic particle comprised in the coating material and the second solution is about 1:1 to 40:1.

7. The method of claim 1, wherein the porous membrane substrate comprises one or more selected from the group consisting of a polyolefin-based resin comprising polyethylene and polypropylene, a fluorine-based resin comprising polyvinylidenefluoride and polytetrafluoroethylene, and a polyester-based resin.

8. The method of claim 7, wherein the porous membrane substrate comprises a pore having a size of about 0.03 to 1 μm, and has a porosity of about 30 to 50% and a thickness of about 10 to 30 μm.

9. A separator manufactured by a method of claim 1.

10. A lithium secondary battery comprising an anode, a cathode, a separator, and an electrolyte,
wherein the separator manufactured by a method of claim 1.
